(19) United States
(12) Patent Application Publication
(10) Pub. No.: US 2006/0182978 A1
(43) Pub. Date: Aug. 17, 2006

(54) Material having sound-damping and adhesive properties

(75) Inventors: Dimitri Leroy, Liege (BE); Yves Lehmann, Liernu (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN PERFORMANCE PLASTICS, Chaineux (BE)

(21) Appl. No.: 10/566,092

(22) PCT Filed: Jul. 21, 2004
(86) PCT No.: PCT/IB04/03543

§ 371 Date: Jan. 27, 2006

(30) Foreign Application Priority Data
Jul. 30, 2003 (FR) 0309387

(51) Int. Cl. B32B 27/00

(52) U.S. Cl. 428/423.1

(57) ABSTRACT

Damping material (3) having a loss factor tan δ at least equal to 0.25 and having two glass transition temperatures, at least one of which is substantially close to the use temperature of the material.

The present invention relates to a damping material that is intended to be inserted between two elements so that noise generated by the vibrations propagating from one element to the other undergoes acoustic attenuation.

This type of material is used for example as a sealing-type strip on vehicle, particularly motor vehicle, windows for the purpose of improving acoustic comfort. The use of the material will be more particularly described in the case of vehicle windows, but this use is in no way limiting and application may be for any elements between which a damping material is inserted, such as glazed walls with partitions in buildings.

Patent DE 198 06 122 describes a strip with an acoustic damping property, placed around the periphery of a window. The strip is used firstly to fasten the window pane to the body of the vehicle, but also plays a damping role. The strip is hollow and filled with a pasty material whose function is to damp the vibrations, the body of the strip being made of a bonding material that becomes elastic after crosslinking.

However, the above solution has the drawback of not ensuring that the stiffness of the strip is sufficient to guarantee the desired acoustic performance.

This is because, firstly, the strip described, which is a coextruded bead, is intended to be compressed between the window and the body, but this method of application by compression combined with the constituent materials of the strip does not guarantee the desired final dimensional shape.

Secondly, the pasty material internal to the body of the strip remains soft and its confinement after compression of the coextruded bead against the body element is not guaranteed, since the body of the strip made of the bonding material is also pasty before crosslinking, which runs the risk of the internal pasty material, while it is being deposited, spilling out beyond the body of the strip.

Another drawback is that it is necessary to combine, and even envelope, the damping material with a bonding material, since the damping material does not have any bonding properties.

Finally, it is always desirable to lower the manufacturing costs and increase the speed of manufacture on a production line for a product, such as a motor vehicle, whether by reducing the quantity of materials to be used, for example for fastening the windows to the vehicle body by bonding, or by the simplicity of the way in which the tasks of combining the constituent elements of the vehicle are carried out, while giving the product an additional property, such as another functionality, that may for example include the bonding material, in particular an acoustic damping property.

Consequently, the object of the invention is to provide a material having an acoustic damping property that also constitutes, if required, a bonding material intended to fasten the two elements together, the material being inserted between the two elements in order to fulfill its acoustic damping role.

Thus, the invention relates to a damping material composed of a single constituent, having a loss factor tans of at least 0.25 and having two glass transition temperatures, at least one of which is substantially close to the use temperature of the material.

It will be recalled that, as is known, the loss factor of a material is defined by the ratio of the dissipativity of the material to the rigidity E′ of the material.

The expression “material composed of a single constituent having two glass transition temperatures” is understood to mean a material made up of course from a plurality of components, as we will see below, but forming in the end a single polymer having two glass transition temperatures, and not a material resulting from a physical blending of two thermoplastic (nonreactive) polymers each having a single glass transition temperature.

According to one feature, it has a rigidity E′ not exceeding 2000 MPa for a frequency between 50 and 500 Hz, preferably less than 1000 MPa, at a temperature between −60° C. and −10° C.

Advantageously, it has a glass transition temperature between −60° C. and −10° C. and a glass transition temperature between −10° C. and +40° C.

According to another feature, it has, at a temperature of between +30° C. and +100° C., a rigidity E′ of between 1 and 200 MPa for a frequency of between 50 and 500 Hz.

The material having the above features comprises:

a) at least one component chosen from:
one-component or two-component polyurethanes based on polyether polyols of the polypropylene glycol, polyethylene oxide (PEO) or polyTHF type or based on polybutadiene polyol, or else based on polycaprolactonepolyol,
polyurethanes with methoxysilane or ethoxysilane end groups, for example SPUR polymers SP XT 53 and SP XT 55 sold by Hanse Chemie and
silane-modified polyether polyols of the polypropylene oxide type (SMP); and

b) at least one component chosen from: plasticized PVC, amorphous polyester polyol, polyester polyol with methoxysilane or ethoxysilane end groups, one-component polyurethane prepolymer, two-component polyurethane.
Preferably, the material comprises a blend of at least two prepolymers, each based on polyether polyol and/or polyester polyol, and with isocyanate end groups or methoxysilane or ethoxysilane end groups.
According to a preferred embodiment, the material having two glass transition temperatures comprises the following blend, the NCO percentage being between 0.5 and 2%:
   at least one polyether polyol of functionality equal to two, having an OH number iOH of between 25 and 35, a glass transition temperature Tg below −50° C., and a molecular weight between 3500 and 4500;
   at least one polyether polyol of functionality between 2.3 and 4, having an OH number iOH of between 25 and 800 and a glass transition temperature Tg below −50° C.;
   at least one polyester polyol of functionality equal to two, having an OH number iOH of between 20 and 40, and a glass transition temperature Tg of between −40 and −20° C.;
   at least one polyester polyol of functionality equal to two, having an OH number iOH of between 30 and 90, a glass transition temperature Tg of between 0 and 30° C. and a softening point of between 50 and 70° C.;
   at least one isocyanate of functionality between 2.1 and 2.7, of the diphenylmethane diisocyanate (MDI) type, and with an NCO percentage of between 11 and 33%;
   at least one catalyst;
   optionally, a filler of the molecular sieve type; and
   optionally, a filler of the chalk, kaolin, talc, alumina, carbon black or graphite type.

According to a first example of the preferred embodiment of the invention, the material comprises, the % NCO being between 1.8 and 2.2%:
between 180 and 220 g of a polyether polyol of functionality equal to two, having an OH number iOH of between 25 and 35, a glass transition temperature Tg below −50° C., and a molecular weight of between 3500 and 4500;
between 75 and 115 g of an MDI-type isocyanate, with a % NCO equal to 11.9%;
between 5 and 30 g of carbon black;
between 0.5 and 3 g of catalyst;
between 10 and 30 g of pyrogenic silica;
between 135 and 180 g of a liquid and amorphous polyester polyol A, having an OH number iOH between 27 and 34, a molecular weight equal to 3500, a functionality equal to two and a glass transition temperature T_{g} of −30° C.;
between 35 and 85 g of a liquid and amorphous polyester polyol B, having an OH number iOH of between 27 and 34, a molecular weight equal to 3500, a functionality equal to two and a glass transition temperature Tg equal respectively to +20° C.;
between 55 and 110 g of an MDI-type isocyanate, with a % NCO equal to 11.9%; and
between 20 and 80 g of a molecular sieve.

According to a second example of the preferred embodiment of the invention, the material comprises, the % NCO being between 1.5 and 1.8%:
between 70 and 130 g of a polyether polyol of functionality equal to two, having an OH number iOH of between 25 and 35, a glass transition temperature Tg below −50° C., and a molecular weight of between 3500 and 4500;
between 70 and 130 g of a polyether polyol of functionality between 2.3 and 4, having an OH number iOH of between 25 and 800 and a glass transition temperature Tg below −50° C.;
between 80 and 110 g of an MDI-type isocyanate, with a % NCO equal to 11.9%;
between 5 and 30 g of carbon black;
between 0.5 and 3 g of catalyst;
between 10 and 30 g of pyrogenic silica;
between 250 and 350 g of a copolyester polyol having an OH number iOH of between 27 and 34, a molecular weight equal to 3500, a maximum acid number equal to two, a functionality equal to two and a Tg equal to −30° C.;
between 100 and 140 g of an MDI-type isocyanate, with a % NCO equal to 11.9%; and
between 20 and 60 g of a molecular sieve.

The invention also relates to the use of the damping material as at least one constituent material of a strip. Advantageously, the strip also has acoustic damping properties and is characterized in that it has an equivalent linear stiffness K′_{eq} at least equal to 25 MPa and an equivalent loss factor tan δ_{eq} at least equal to 0.25.

It will be recalled that the stiffness is a quantity that links the deformation of the strip to the force applied to it. The stiffness is defined by the rigidity of the materials constituting the strip and by the geometry of the strip, the rigidity being a characteristic quantity of the material, which essentially depends on the Young's modulus E′.

As is known, the equivalent linear stiffness K*_{eq} is a complex number that can be written as K*_{eq}=K′_{eq}+jK″_{eq}, where K′_{eq} is the real part, which may be called the equivalent real linear stiffness, and K″_{eq} is the imaginary part, which corresponds to the dissipativity, that is to say the ability of the deformation energy of the strip to be transformed into thermal energy within the entire strip.

Moreover, the equivalent loss factor tan δ_{eq} is defined by the equation:

$$tan {δ}_{eq} = \frac{{K}^{″}}{{K}^{′}} .$$

To determine the equivalent real linear stiffness K′_{eq}, the dissipativity K″_{eq} and the equivalent loss factor tan δ_{eq} of a strip consisting of one or more materials, the quantities K′_{eq} and K″_{eq} are estimated using a viscoanalyzer, and the equivalent loss factor tan δ_{eq} is calculated by taking the ratio K″_{eq}/K′_{eq}.

As a variant, the material may be used in the form of a layer possessing permanent bondability, this layer being coated on its two opposed faces intended for bonding, with protective films. For this purpose, the material is chemically modified by a reaction between the terminal isocyanates of the prepolymers and the monols.

The material of the invention is joined to at least one element using an extrusion, encapsulation, transfer molding or injection molding technique.

In its use, the material is intended to be inserted between two elements of the glass-metal, metal-metal, glass-glass, metal-plastic, glass-plastic or plastic-plastic type.

It will advantageously be used also as material for bonding to at least one of the elements. Thus, it is inserted, for example, between a glass substrate and a metal element so as to be used to fasten the substrate to the metal element, for example in order to fasten a window to the body of a motor vehicle.

Nothing prevents, depending on the method of manufacture, for example on batch lines for producing, for example, products incorporating elements that have to be provided with the damping material, an additional fastening material being used to bond the damping material to the element to which it is intended to be joined. The additional fastening material may also be a damping material of the invention.

Other advantages and features of the invention will become apparent in the rest of the description with regard to the appended drawings, in which:

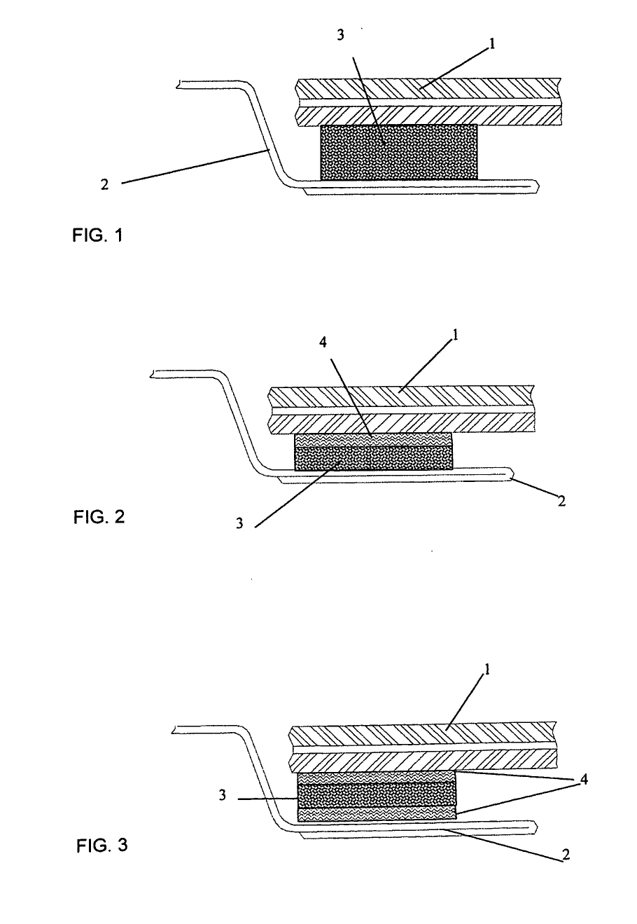

FIG. 1 shows a partial sectional view of two elements joined together by means of a strip formed by the material of the invention; and

FIGS. 2 and 3 show alternative embodiments in partial sectional view of two elements joined together by means of a strip comprising at least the material of the invention.

FIG. 1 is a partial sectional view of a window 1 joined to a carrier element 2, such as a motor vehicle body. The window, consisting of at least one glass substrate, is fastened to the body by means of a strip 3 formed by the material of the invention having acoustic damping and bonding properties.

Consequently, the material used for the strip 3 joined to and inserted between two elements 1 and 2, which here, as an example, are the body and the window respectively, fulfills, apart from its vibration damping role according to the invention, the role of device for fastening the two elements together while providing a sealing function in order to protect the passenger compartment of the vehicle from environmental attack, such as by dust, moisture, water.

However, the material used for its bonding function may not be fastened directly to the elements between which it fulfills its acoustic damping role, but rather may be joined to at least one material, called in the rest of the description the fastening material, which fulfills as such a role of fastening to said element or elements (FIGS. 2 and 3). The material of the invention will in any case fulfill a role of bonding to the fastening material, which may also consist of the damping and bonding material of the invention.

The material of the invention has two glass transition temperatures, an ambient glass transition temperature between −10° C. and +40° C., for which the material fulfills its damping role, and a lower glass transition temperature between −60° C. and −10° C., for which the bonding function is maintained, that is to say a temperature at which there is no risk of adhesive failure with the element to which the material is joined.

It will be recalled that the glass transition temperature corresponds to the temperature for which the loss factor tan δ is a maximum.

It will be recalled that the loss factor tan δ can be written in the following manner:

$$tan δ = \frac{{E}^{″}}{{E}^{′}} ,$$

where E′ is the rigidity of the material and E″ is the dissipativity, that is to say the ability of the deformation energy of the material to be transformed into thermal energy in the material.

In the invention, the damping role of the material is defined by the value that the loss factor tans of the material must have, which is greater than 0.25.

The invention also attributes the durability of the bonding at low temperature, when the rigidity or Young's modulus E′ of the material is less than or equal to 2000 MPa for a frequency of between 50 and 500 Hz.

The tan δ and E′ measurements are estimated using a viscoanalyzer, an apparatus well known to those skilled in the art, such as experts in polymers and acoustics. The viscoanalyzer measures Young's modulus E′ and the dissipativity E″, which makes it possible to obtain the value of Young's modulus E′ and to obtain, by calculating the ratio E″/E′, the loss factor tan δ.

The viscoanalyzer is, for example, the one sold under the brand name METRAVIB. The measurement conditions are given below:

sinusoidal stressing;

test piece of the material consisting of a rectangular parallelepiped having dimensions such that they fall within the ranges defined by the manufacturer of the viscoanalyzer, for example:
thickness e=3 mm
width L=5 mm
height=10 mm

dynamic amplitude: ±5×10⁻⁶ m about the rest position;

frequency range: 5 to 400 Hz;

temperature range: −60 to +60° C.

The material of the invention may comprise a blend of at least one plasticized or unplasticized polyvinyl chloride and/or of at least one one-component or two-component polyurethane which may or may not be modified by an elastomer, such as polyolefins, EPDM (ethylene-propylene-diene), or rubber, especially butyl, nitrile or styrene-butadiene rubber, and optionally at least one catalyst.

In particular, this is a blend of:

a) at least one component chosen from:
one-component or two-component polyurethanes based on polyether polyols of the polypropylene glycol, polyethylene oxide (PEO) or polyTHF type or based on polybutadiene polyol, or else based on polycaprolactonepolyol,
polyurethanes with methoxysilane or ethoxysilane end groups, for example SPUR polymers SP XT 53 and SP XT 55 sold by Hanse Chemie, and
silane-modified polyether polyols of the polypropylene oxide type (SMP); and

b) at least one component chosen from: plasticized PVC, amorphous polyester polyol, polyester polyol with methoxysilane or ethoxysilane end groups, one-component polyurethane prepolymer, two-component polyurethane.

It should be noted that the advantage of a prepolymer having methoxysilane or ethoxysilane, preferably methoxysilane, end groups is that it is moisture-curable without foaming. These polyurethane compositions may be modified by an elastomer, especially nitrile, SBR or butyl rubber, or by a thermoplastic elastomer, or else by a noncrosslinkable polymer having a certain flexibility, such as polyolefins or plasticized PVC.

Among moisture-curable and/or heat-curable one-component polyurethane prepolymer compositions, these are obtained by reaction between polymeric or nonpolymeric diisocyanates (whether aliphatic or aromatic) and polyols.

The polyols of the compositions may be polyether polyols of the type comprising: polyethylene, propylene oxide, polytetramethylene oxide, polycarbonatepolyol or polybutadienepolyol, polyesterspolyols, whether amorphous or crystalline, aromatic or aliphatic, based on a fatty acid dimers, aromatic or aliphatic diacids, castor oil, chain extenders of the 1,3- or 1,4-butanediol, diisopropyl glycol, 2,2-dimethyl-1,3-propanediol, hexanediol and carbitol type. The molecular weight of these polyols will be defined by their hydroxyl number (iOH) defined according to the ASTM E 222-94 standard as the number of milligrams of potassium hydroxide equivalent to a hydroxyl content of 1 gram of polyol. The iOH range used is between 5 and 1500. The functionality of these polyols will be between 2 and 6.

The isocyanates may be aromatic or aliphatic, among which are diphenylmethane diisocyanates (MDI), toluene diisocyanates (TDI), isophorone diisocyanates (IPDI), and hexane diisocyanate (HDI). The nature of the isocyanates is also defined by their percentage of NCO, which, according to the ASTM D 5155-96 standard, is defined as the proportion by weight of isocyanate (NCO) functional groups present in the product. The functionality of the products is between 2.1 and 2.7.

The catalysts needed for the reaction between the polyols and the isocyanates may be tin catalysts, such as dibutyltin dilaurate (DBTDL) and tin octoate. It is also possible to use bismuth catalysts or catalysts based on morpholines, such as dimorpholinodiethyl ether (DMDEE).

The abovementioned components of the material may furthermore contain organic or mineral fillers, such as talc, silica, calcium carbonate, kaolin, alumina, molecular sieve, carbon black, graphite, pyrogenic silica, glass microbeads, metal fillers, such as zinc oxide, titanium oxide, alumina, magnetite, or micronized lead. The filler content may vary between 0 and 50% by weight of the final composition.

Moreover, to prevent the chosen prepolymer from foaming, it may be advantageous to add an antifoam additive, which is a compound based on bis-oxazolidines. Finally, various plasticizers may advantageously also be added to the chosen prepolymer.

Thus, the material of the invention may comprise the following preferred blend:
at least one polyether polyol of functionality equal to two, having an OH number iOH of between 25 and 35, a glass transition temperature Tg below −50° C., and a molecular weight between 3500 and 4500;
at least one polyether polyol of functionality between 2.3 and 4, having an OH number iOH of between 25 and 800 and a glass transition temperature Tg below −50° C.;
at least one polyester polyol of functionality equal to two, having an OH number iOH of between 20 and 40, and a glass transition temperature Tg of between −40 and −20° C.;
at least one polyester polyol of functionality equal to two, having an OH number iOH of between 30 and 90, a glass transition temperature Tg of between 0 and 30° C. and a softening point of between 50 and 70° C.;
at least one isocyanate of functionality between 2.1 and 2.7, of the diphenylmethane diisocyanate (MDI) type, and with an NCO percentage of between 11 and 33%;
at least one catalyst;
optionally, a filler of the molecular sieve type; and
optionally, a filler of the chalk, kaolin, talc, alumina, carbon black or graphite type.

The percentage of NCO of this polyurethane prepolymer is between 0.5 and 2%.

An example of the material (Example 1) according to the composition or blend described above is the following:

for a final blend weighing 800 g:

218 g of a polyether polyol of functionality equal to two, having an OH number iOH of between 25 and 35, a glass transition temperature Tg below −50° C. and a molecular weight between 3500 and 4500 (for example Lupranol 2043™ sold by BASF)
96 g of an MDI-type isocyanate, with a % NCO equal to 11.9%;
16 g of carbon black; and
1.5 g of DMDLS as catalyst, sold by Huntsman, or PC CAT DMDEE sold by Nitroil.

All the above components were blended in order to form a first preblend. The reaction was carried out for one hour, and then 16 g of pyrogenic silica (for example AEROSIL 200™ sold by Degussa) were dispersed for 5 minutes.

A second preblend was produced from:
167 g of a liquid and amorphous polyester polyol A, sold for example by Degussa, with an OH number iOH of between 27 and 34, a molecular weight equal to 3500, a functionality equal to two and a glass transition temperature Tg equal to −30° C.;
73 g of a liquid amorphous polyester polyol B, sold for example by Degussa, having an OH number iOH of between 27 and 34, a molecular weight equal to 3500, a functionality equal to two and a glass transition temperature Tg equal to respectively +20° C.; and
83 g of an MDI-type isocyanate, with a % NCO equal to 11.9%.

This second preblend was then added to the first preblend. The reaction was carried out for an additional hour, and then 40 g of molecular sieve were dispersed for 5 minutes and the finished product constituting the material of the invention was then packaged in sealed packaging. The % NCO of the finished product was between 1.8 and 2.2%.

The Young's modulus and loss factor values at 120 Hz and 20° C. for this example 1 were the following: E′=22 MPa and tan δ=0.75. The value of Young's modulus at a temperature of −40° C. was 900 MPa.

Another example (Example 2) was the following:

for a final blend weighing 800 g:
107 g of a polyether polyol of functionality equal to two, having an OH number iOH of between 25 and 35, a glass transition temperature Tg below −50° C. and a molecular weight between 3500 and 4500;
107 g of a polyether polyol of functionality between 2.3 and 4, having an OH number iOH of between 25 and 800, a glass transition temperature Tg below −50° C., for example Lupranol 2090™ sold by BASF;
96 g of an MDI-type isocyanate, with a % NCO equal to 11.9% (for example MP 130 sold by BASF),
16 g of carbon black; and
1.5 g of DMDLS as catalyst, sold by Huntsman, or of PC CAT DMDEE, sold by Nitroil.

All the above components were blended in order to form a first preblend. The reaction was carried out for one hour, and then 16 g of pyrogenic silica (for example AEROSIL 200 sold by Degussa) were dispersed for 5 minutes.

A second preblend was produced from:
323 g of a copolyester polyol having an OH number iOH of between 27 and 34, a molecular weight of 3500, a maximum acid number equal to two, a functionality equal to two and a Tg equal to −30° C.; for example a copolyester polyol sold by Degussa and based on a reaction between ethylene glycol, diethylene glycol and neopentyl glycol on the one hand and adipic and terephthalic acids on the other; and
121 g of an MDI-type isocyanate, with a % NCO equal to 11.9%.

This second preblend was then added to the first preblend. The reaction was carried out for an additional one hour, and then 40 g of molecular sieve were dispersed for 5 minutes and the finished product was packaged in sealed packaging. The % NCO of the finished product was between 1.5 and 1.8%.

The Young's modulus and loss factor values at 120 Hz and 20° C. for the damping material were the following: E′=17 MPa and tan δ=0.42. The Young's modulus E′ value at a temperature of −40° C. was 700 MPa.

The material of the invention, thus having two glass transition temperatures, one consequently a low-temperature glass transition temperature of between −60° C. and −10° C., with the Young's modulus E′ less than or equal to 2000 MPa, makes it possible to maintain the bonding, with the element to which the material is joined, at temperatures of between −60° C. and −10° C.

The table below illustrates examples of compositions of materials of the invention for which the Young's modulus is less than 2000 MPa at a temperature of −40° C. (measurements carried out at a frequency of 120 Hz) and ensures effective damping at a temperature of between −10° C. and +40° C., having a loss factor tan δ of greater than 0.25.

It should also be noted that, when the material is used as damping material, it is necessary to consider the loss factor tan δ at the temperature at which the material will be used. Thus, the first material example in the table below, having a loss factor tan δ equal to 0.15 at −40° C. and equal to 0.8 at −10° C., will not be suitable if it is desired to use it at −40° C., but it will be very satisfactory at a temperature of −10° C.

| | E′ at | Maximum tanδ | |
|---|---|---|---|
| | −40° C. | between −10° C. | Maximum tanδ |
| Two-component blend with a 40/60 weight ratio | (MPa) | and +40° C. | at −40° C. |
| Polyether polyol-based one-component polyurethane/polyester polyol-based | 500 | 0.8 at −10° C. | 0.15 |
| one-component polyurethane | | | |
| Polyether polyol-based one-component polyurethane/PVC plasticized with 50% | 9 | 0.33 at 0° C. | 0.75 |
| diisodecyl phthalate with a K factor of 73 | | | |
| Polyether polyol-based one-component polyurethane/PVC plasticized with 100% | 15 | 0.42 at 0° C. | 0.65 |
| diisodecyl phthalate with a K factor of 73 | | | |
| Polyether polyol-based one-component polyurethane with silane end groups/amorphous | 160 | 0.85 at +40° C. | 0.5 |
| polyester polyol | | | |
| Polyether polyol-based one-component polyurethane with silane end groups/polyester | 50 | 0.45 at +10° C. | 0.62 |
| polyol-based one-component polyurethane | | | |

Furthermore, it may be advantageous for the material of the invention to be able, at a temperature above room temperature, that is to say at a temperature between +30° and +100° C., to avoid cohesive failure with the element to which the material is joined, the material then having to have a rigidity E′ of between 1 and 200 MPa.

Comparative adhesion tests were carried out between materials according to the invention having two glass transition temperatures, including consequently one at low temperature, and materials having a single glass transition temperature at ambient temperature and having the acoustic damping property.

The adhesion property of the crosslinked material are carried out at various temperatures and on various substrates by means of 90° peel tests on a tensile testing machine. For further details about the nature of the tests, the reader may refer to the Renault recommendations D511709/C for the bonding of mastic to fixed windows.

Strips of the material 1 cm in width, 4 mm in thickness and 15 cm in length were applied to the substrates in question and these strips were left to crosslink for seven days in a controlled atmosphere (23° C. and 50% relative humidity).

The peel test was then carried out at 90°, perpendicular to the substrate, at a rate of 100 mm/min. The type of failure (adhesive or cohesive) and the peel force in N/linear cm were recorded. This peel force corresponds to the force for which the material starts to debond from the substrate in the case of adhesive failure and the force for which the material breaks in the case of cohesive failure.

The values given in the table below were obtained from glass substrates to which specimens of materials of the invention and the materials of the comparative examples were bonded. The peel tests were carried out at −35° C. and at +25° C. The measurements of Young's modulus E′ were carried out at a frequency of 120 Hz.

Examples 1 and 2 (Ex. 1 and Ex. 2) correspond to the materials of Examples 1 and 2 described above.

Comparative Examples 3, 4 (Ex. 3 and Ex. 4) correspond to damping materials at a temperature of between −10° C. and +40° C. having only a single glass transition temperature, in the −10° C. to +40° C. range.

Comparative Example 5 (Ex. 5) corresponds to a bonding material that is nondamping at a temperature between −10° C. and +40° C., such as a polyurethane bonding mastic (Gurit Betaseal 1815 sold by Dow Automotive).

| | −35° C. peel | +25° C. peel | | Maximum | Maximum |
|---|---|---|---|---|---|
| | force | force | | tanδ at a | tanδ at a |
| | (N/cm)/ | (N/cm)/ | | glass | glass |
| | failure | failure | | transition | transition |
| | mode | mode | | temperature | temperature |
| | (adhesive | (adhesive | Young's | between | between |
| | or | or | modulus at | −10° C. and | −60° C. and |
| Specimen | cohesive) | cohesive) | −40° (MPa) | +40° C. | −10° C. |
| Ex. 1 | 50/ | 60/ | 900 | 0.75 at 0° C. | 0.38 at −42° C. |
| | cohesive | cohesive | | | |
| Ex. 2 | 65/ | 80/ | 700 | 0.72 at 11° C. | 0.42 at −38° C. |
| | cohesive | cohesive | | | |
| Ex. 3 | 0/adhesive | 45/ | 3000 | 1.35 at 15° C. | |
| | | cohesive | | | |
| Ex. 4 | 0/adhesive | 35/ | 2600 | 1.11 at 7° C. | |
| | | cohesive | | | |
| Ex. 5 | 62/ | 70/ | 350 | | 0.85 at −38° C. |
| | cohesive | cohesive | | | |

It may be seen that specimens Ex. 3 and Ex. 4 having a single glass transition temperature are, although damping materials with the tan δ characteristic being greater than 0.25, much too rigid at low temperature (E′ greater than 2000 MPa at −40° C.) and therefore do not pass the peel test (0 N/cm force at −35° C.).

Specimen Ex. 5 having a single glass transition temperature passes the peel test at low temperature (−35° C.), therefore having a suitable rigidity (350 MPa), and also at room temperature (+35° C.), but it not at all damping at a use temperature at room temperature, of around 20° C. (the loss factor tans measured at 20° C. being equal to 0.2).

However, specimens Ex. 1 and Ex. 2, having two glass transition temperatures and a suitable rigidity of less than 2000 MPa, passed the peel tests both at low temperature (−35° C.) and at ambient temperature (+25° C.) and are damping at a use temperature of about −40° C. or at a temperature of around 0 or 10° C. The glass transition temperatures given here correspond to the tan δ values for which tan δ is a maximum, but it is sufficient, at other desired use temperatures, for tan δ to be greater than 0.25 in order for the material to have its acoustic damping property.

In general, the strip 3 is applied between the elements 1 and 2 in the following manner: the strip 3 made of the material of the invention is deposited on the element 1 by an application technique that we will describe below. The strip is then bonded to the element 1.

The second element 2 is then either applied directly to the strip 3 and is fastened by bonding, by applying pressure against the element 2. Alternatively, the strip 3 is crosslinked and then only the element 2 is applied by fastening via an additional fastening material 4, which may also be the damping and bonding material of the invention (FIG. 2).

It is also possible to envision another application, for example in which the damping material of the invention is fastened to each of its opposed faces with the element 1 and the element 2, respectively, by means of two additional fastening materials 4 (FIG. 3).

The material is crosslinked in various ways, depending on the composition of said material, for example at room temperature, or at high temperature using an energy source of the infrared, ultraviolet, high-frequency, microwave or induction type.

The material may be applied against at least one of the elements to be joined together by different techniques: extrusion, overmolding (encapsulation), transfer molding and injection molding.

The extrusion technique guarantees a constant strip profile. The damping material according to the invention must have viscosities of between 100 and 500 Pa·s at 80° C., the materials solidifying below 50° C. The materials will therefore have a green strength and exhibit sufficient thixotropy to maintain their geometry after extrusion.

The technique of overmolding the material onto one of the elements advantageously allows it to be given any of the desired shapes and thus allows the acoustic performance to be optimized, while guaranteeing the dimensions of the strip at any point on the window, as it may be necessary for the width and the thickness of the strip not to be uniform over the entire perimeter of the element to which it is joined, for acoustic performance requirements. The viscosity of the materials used must not exceed a certain limit and the two-component product must set rapidly.

With regard to the transfer molding process, the reader may refer for further details to French Patent Application FR 01/15039. Thus, the material is molded and transferred onto one of the elements in order to preserve the advantages of molding and to reduce the mold production costs. This technique combines the advantages of extrusion and overmolding, as it makes it possible to create several layers of materials if required. As in the case of extrusion, a green strength and a minimum viscosity of the materials are required in the case of moisture-crosslinking one-component materials. The setting time may be rapid if thermally crosslinking one-component systems are employed. As regards two-component systems, these set rapidly.

With regard to injection molding, the element that has to be joined to the material is placed in a mold having a cavity corresponding to the shapes of the strip that it is desired to produce and the molding material formed by the damping material is injected in the molten state into the mold.

It will be recalled that the material of the invention is formed from a blend of, for example, at least two one-component polyurethane prepolymers. The blend may be produced as described in the case of Examples 1 and 2; in this case, the material will be applied by extrusion using a single nozzle.

However, as a variant, the blend may be produced during application, for example by extrusion; the two prepolymers will be blended in a mixing head just before the extrusion onto the element to which the material is applied. In yet another variant, the blend of polyols could react with the isocyanate(s) in a blending head of the machine suitable for two-component polyurethane chemistry, just before the extrusion onto the element to which the material is applied.

It is also possible to physically foam the material just before it is extruded for applying to the element, by injecting a pressurized gas, such as nitrogen, either into the blending head or into a suitable blender such as that sold under the name SEVAFOAM by the company SEVA.

Application of the material in the form of a strip has been described by way of example. This material may advantageously be chemically modified in order to deliver it in the form of a thin layer possessing permanent bondability, this layer being coated, on two opposed faces intended for bonding, with a protective film that can be removed before the layer is applied against an element to which the material has to be applied. The chemical modification is carried out by a reaction between the terminal isocyanates of the prepolymers and the monols.

The strip of the invention having an acoustic damping property has been described by way of example in the case of being inserted between two elements 1 and 2, such as a glass substrate and a body of a motor vehicle, for the purpose of fastening them to one another, and therefore for a glass-metal joint. Other applications may be envisioned for using the acoustic damping strip of the invention, for example for metal/metal, glass-glass, metal-plastic, glass-plastic and plastic-plastic joints. The term “plastic” is understood to mean plastics such as epoxy, polyester, polycarbonate, polymethyl methacrylate (PMMA), acrylonitrile butadiene styrene, or composites based on a plastic, such as polypropylene (PP), and reinforcing fibers, such as glass fibers or wood fibers.

For a metal-metal joint, the metal parts are, for example, bonded to the body of a vehicle. Thus, mechanical elements for opening the doors and windows, which are usually fastened by means of bolts, may instead by fastened by bonding by means of a damping strip of the invention in order to attenuate the radiation of noise into the interior of the passenger compartment of the vehicle.

In the case of a glass-plastic joint, this may for example involve the fastening of a rear window of the vehicle.

In the case of a plastic-plastic or plastic-metal joint, this may involve for example the bonding of the various elements constituting the tailgate of a motor vehicle, or else the assembly, by bonding, of a roof based on a glass-fiber-reinforced polyurethane foam to the metal body of the vehicle.

1. A damping material comprising:
a single constituent, having a loss factor tan δ of at least 0.25 and having two glass transition temperatures, at least one of which is substantially close to the use temperature of the material.

2. The damping material as claimed in claim 1, which has a rigidity E′ not exceeding 2000 MPa for a frequency between 50 and 500 Hz at a temperature between −60° C. and −10° C.

3. The damping material as claimed in claim 1, which has a glass transition temperature between −60° C. and −10° C. and a glass transition temperature between −10° C. and +40° C.

4. The damping material as claimed in claim 1, which has at a temperature of between +30° C. and +100° C., a rigidity E′ of between 1 and 200 MPa.

5. The damping material as claimed in claim 1, comprising:
a) at least one component of:
one-component or two-component polyurethanes based on polyether polyols of the polypropylene glycol, polyethylene oxide (PEO) or polyTHF type or based on polybutadiene polyol, or else based on polycaprolactonepolyol,
polyurethanes with methoxysilane or ethoxysilane end groups, and
silane-modified polyether polyols of the polypropylene oxide type; and
b) at least one component of: plasticized PVC, amorphous polyester polyol, polyester polyol with methoxysilane end group, polyester polyol with ethoxysilane end group, one-component polyurethane prepolymer, and two-component polyurethane.

6. The damping material as claimed in claim 5, which comprises a blend of at least two prepolymers, each based on polyether polyol and/or polyester polyol, and with isocyanate end groups or methoxysilane or ethoxysilane end groups.

7. The damping material as claimed in claim 6, which comprises the following blend, the NCO percentage being between 0.5 and 2%:
at least one polyether polyol of functionality equal to two, having an OH number iOH of between 25 and 35, a glass transition temperature Tg below −50° C., and a molecular weight between 3500 and 4500;
at least one polyether polyol of functionality between 2.3 and 4, having an OH number iOH of between 25 and 800 and a glass transition temperature Tg below −50° C.;
at least one polyester polyol of functionality equal to two, having an OH number iOH of between 20 and 40, and a glass transition temperature Tg of between −40 and −20° C.;
at least one polyester polyol of functionality equal to two, having an OH number iOH of between 30 and 90, a glass transition temperature Tg of between 0 and 30° C. and a softening point of between 50 and 70° C.;
at least one isocyanate of functionality between 2.1 and 2.7, of the diphenylmethane diisocyanate (MDI) type, and with an NCO percentage of between 11 and 33%; and
at least one catalyst.

8. The damping material as claimed in claim 7, which comprises, the % NCO being between 1.8 and 2.2%:
between 180 and 220 g of a polyether polyol of functionality equal to two, having an OH number iOH of between 25 and 35, a glass transition temperature Tg below −50° C., and a molecular weight of between 3500 and 4500;
between 75 and 115 g of an MDI-type isocyanate, with a % NCO equal to 11.9%;
between 5 and 30 g of carbon black;
between 0.5 and 3 g of catalyst;
between 10 and 30 g of pyrogenic silica;
between 135 and 180 g of a liquid and amorphous polyester polyol A, having an OH number iOH between 27 and 34, a molecular weight equal to 3500, a functionality equal to two and a glass transition temperature T_{g} of −30° C.;
between 35 and 85 g of a liquid and amorphous polyester polyol B, having an OH number iOH of between 27 and 34, a molecular weight equal to 3500, a functionality equal to two and a glass transition temperature Tg equal respectively to +20° C.;
between 55 and 110 g of an MDI-type isocyanate, with a % NCO equal to 11.9%; and
between 20 and 80 g of a molecular sieve.

9. The damping material as claimed in claim 7, which comprises, the % NCO being between 1.5 and 1.8%:
between 70 and 130 g of a polyether polyol of functionality equal to two, having an OH number iOH of between 25 and 35, a glass transition temperature Tg below −50° C., and a molecular weight between 3500 and 4500;
between 70 and 130 g of a polyether polyol of functionality between 2.3 and 4, having an OH number iOH of between 25 and 800 and a glass transition temperature Tg below −50° C.,
between 80 and 110 g of an MDI-type isocyanate, with a % NCO equal to 11.9%;
between 5 and 30 g of carbon black;
between 0.5 and 3 g of catalyst;
between 10 and 30 g of pyrogenic silica;
between 250 and 350 g of a copolyester polyol having an OH number iOH of between 27 and 34, a molecular weight equal to 3500, a maximum acid number equal to two, a functionality equal to two and a Tg equal to −30° C.;
between 100 and 140 g of an MDI-type isocyanate, with a % NCO equal to 11.9%; and
between 20 and 60 g of molecular sieve.

10. The damping material as claimed in claim 1, which is used as at least one constituent material of a strip.

11. The damping material as claimed in claim 1, wherein the strip has an equivalent linear stiffness K′_{eq} at least equal to 25 MPa and an equivalent loss factor tan δ_{eq} at least equal to 0.25 at the use temperature.

12. The damping material as claimed in claim 1, which is in the form of a layer possessing permanent bondability by chemical modification of the material carried out by a reaction between the terminal isocyanates of the prepolymers and the monols, its two opposed faces intended for bonding being coated with protective films.

13. The damping material as claimed in claim 1, which is intended to be joined to at least one element using an extrusion, encapsulation, transfer molding or injection molding technique.

14. The damping material as claimed in claim 1 which is intended to be inserted between two elements (1, 2) of the glass-metal, metal-metal, glass-glass, metal-plastic, glass-plastic, or plastic-plastic type.

15. The damping material as claimed in claim 14, which is used also as a material for bonding to at least one of the elements.

16. The damping material as claimed in claim 13, which is inserted between a glass substrate and a metal element so as to be used to fasten the substrate to the metal element.

17. The damping material as claimed in claim 14, which is used to fasten a window to the body of a motor vehicle.

18. The damping material as claimed in claim 13, wherein an additional fastening material bonds the damping material to the element to which it is intended to be joined.

19. The damping material as claimed in claim 18, wherein the additional fastening material is a damping material as claimed in claim 1.

20. The damping material as claimed in claim 6 further comprising: a filler of the molecular sieve type and/or a filler of the chalk, kaolin, talc, alumina, carbon black, or graphite type.
